(19) United States
(12) Patent Application Publication
(10) Pub. No.: US 2006/0101978 A1
(43) Pub. Date: May 18, 2006

(54) Apparatus and method for enhanced dynamics on MIDI-enabled reproducing player pianos

(75) Inventors: David Honeywell, Lincoln, CA (US); Mark Van Sant, Oregon House, CA (US)

Correspondence Address: JOHN P. O'BANION;O'BANION & RITCHEY LLP, 400 CAPITOL MALL SUITE 1550, SACRAMENTO, CA, 95814, US

(73) Assignee: BURGETT, INC.

(21) Appl. No.: 11/001,632

(22) Filed: Nov. 30, 2004

Related U.S. Application Data
(60) Provisional application No. 60/629,162, filed on Nov. 17, 2004.

(51) Int. Cl. G10F 1/02; G10H 7/00

(52) U.S. Cl. 84/13; 84/645

(57) ABSTRACT

An apparatus and method for providing minimum note velocity compensation within a player piano, or other instrument, without compromising upper volume range note velocity consistency. The minimum note velocity which needs to be applied to each of the keys in order to generate an audible response, or a response discernable either acoustically, optically, or mechanically, is determined. The minimum note velocity information is stored within the driver circuit, such as in a separate table or as part of an expression table. The received note velocity value has fewer velocity states in its range of input values than are available for output by the driver circuit, wherein minimum note velocity compensation can be performed without detracting from upper end note velocity consistency. The compensation provides improved upper end velocity performance while providing the ability to accurately playback a MIDI stream that is not processed by the control box.

### CROSS-REFERENCE TO RELATED APPLICATIONS

This application claims priority from U.S. provisional application Ser. No. 60/629,162 filed on Nov. 17, 2004, incorporated herein by reference in its entirety.

### STATEMENT REGARDING FEDERALLY SPONSORED RESEARCH OR DEVELOPMENT

Not Applicable

### INCORPORATION-BY-REFERENCE OF MATERIAL SUBMITTED ON A COMPACT DISC

Not Applicable

### NOTICE OF MATERIAL SUBJECT TO COPYRIGHT PROTECTION

A portion of the material in this patent document is subject to copyright protection under the copyright laws of the United States and of other countries. The owner of the copyright rights has no objection to the facsimile reproduction by anyone of the patent document or the patent disclosure, as it appears in the United States Patent and Trademark Office publicly available file or records, but otherwise reserves all copyright rights whatsoever. The copyright owner does not hereby waive any of its rights to have this patent document maintained in secrecy, including without limitation its rights pursuant to 37 C.F.R. § 1.14.

### BACKGROUND OF THE INVENTION

1. Field of the Invention

This invention pertains generally to circuitry for electronically controlled player pianos and similar automated electromechanical musical instruments, and more particularly to minimum note velocity compensation.

2. Description of Related Art

Player pianos have continued to gain sophistication toward optimizing performance reproduction. One of the problems, however, in achieving accurate playback is that the required level of actuation to provide a given level of audio output is not the same for every key. Each solenoid-key combination of the piano requires that a different level of force be applied to it in order to achieve a given level of audio output. Consequently, with uncorrected outputs the note velocity values received by the piano, such as encoded in a musical instrument data interchange (MIDI) note stream, are not accurately reproduced in terms of the audio level being output.

To correct for these variations a “learn” mode is adopted in some player pianos which calibrates a response based on minimum audio levels.

During this “learn” mode each key is played at successively higher note velocity values until the hammer discernibly, but quietly, strikes a key. This discernable note velocity is referred to as the “minimum note velocity”. Minimum note velocity is determined for each key on the piano and stored in a “learn table” within the control box.

During playback the learn table data is utilized to compensate note velocities. In operation, some current player piano systems receive a MIDI-based note velocity, perform the minimum note compensation, and then output a MIDI-based output (value in the range 0 to 127), compensated for minimum note velocity, to the driver circuit. As a note value is received within the MIDI stream the control system (control box) looks up the minimum note velocity for that key and adds it to the requested velocity for the note in the note stream. However, a slight problem is created at the upper end of the note volume range since the number of available velocity states is constrained by the velocity format (i.e. MIDI), therein reducing the volume consistency between keys.

Consider the following example scenario in which the minimum note velocity on a particular piano instrument for a note C is 10, for D is 15, and for G is 2. It should be recognized that the keys of each instrument will require different minimum note velocity compensations. It should also be understood that if optimum note consistency is desired minimum note velocity compensation may need to be performed regularly on a piano due to changes as the piano ages and/or in response to temperature and humidity fluctuations. In this scenario consider the case of a MIDI note string providing an equal note velocity of 40 for each of these keys. In this case the actual outputs to the solenoids after compensating for minimum note velocity would range from 42 to 55. This compensation example is given by Table 1, wherein the minimum note velocity for note C was used to compensate the requested value of 40 by adding 10 to it so that a note velocity value of 50 is output to the driver circuit. It will be seen that note G only required a small compensation value of 2, while note D required a compensation of 15. Therefore, it will be recognized that a note velocity value of 1 received for note C would result in an output for note C of 11. Similarly, an input of 1 for note D would result in an output of 16, while for note G an input of 1 would result in an output value of 3.

Although this minimum velocity compensation properly corrects for the sound levels at low volume it should be recognized that the available range of MIDI outputs diminishes accordingly. For example, a requested MIDI note velocity for C of 117 in this scenario results in a maximum MIDI value being output of 127. In addition, any requested velocity values at or exceeding 117 for note C (which has a minimum note velocity of 10 for this example) will result in the same compensated MIDI output of 127. As a result, high note velocities are not well represented and vary from note to note based on the minimum note velocity value for that key. It will be seen that note G will only output a MIDI output of 127 for requested note velocities of at least 125.

FIG. 1 is a flowchart depicting an example of this conventional MIDI key processing and driving technique. Represented by block 10 is the process of determining the minimum note velocity for each of the keys during a calibration process, the results being stored as per block 12 within control box memory, after which other functions may be performed by the control box.

During playback a note is read as per block 14 from a data source generating a formatted note stream including note velocity information. A popular note stream format is MIDI, although the teachings herein can be applied to other note formats which include a note velocity specifier. The minimum note velocity determined during the learn mode is added to the requested note velocity value as given by block 16. The modified note velocity value is output to the driver system of the player piano at block 18 and the driver system picks the corresponding force from the expression table in block 20 and drives the solenoid as per block 22 to play the note.

The use of minimum volume note compensation can reduce low volume range audio inconsistencies, but it can also introduce playback inconsistencies in the higher ranges of note playback velocity.

Accordingly, a note velocity compensation technique is needed which can compensate for minimum note velocities within the instrument without sacrificing high note velocity consistency. The present invention fulfills that need and others while overcoming drawbacks with existing techniques.

### BRIEF SUMMARY OF THE INVENTION

The present invention comprises a method of controlling note velocity within an electronically controlled player piano. The invention provides correction of the velocity values within the driver section based on empirically derived minimum note velocities collected during a learning mode. The correction is based on a learning table and performed without reducing the number of usable velocity levels received by the solenoid driver circuit.

It has not been fully appreciated by the industry that compensating for minimum note velocity within the control box and passing corrected note velocity values to the driver circuit results in a prospective loss of upper end velocity drive levels, depending on the amount of minimum note velocity compensation which has been applied. Typically, a conventional control box receives a MIDI stream, applies the minimum note velocity compensation value, and outputs a MIDI note with corrected velocity value to the solenoid driver circuit. The solenoid driver circuit generates an output to drive the solenoids in response to the MIDI note received. In some embodiments the solenoid driver looks up desired drive values in an expression table to convert the received MIDI value to a proper force value for the driver.

The method and apparatus of the present invention recognizes the consistency problems which arise from correcting for minimum note velocity within the control box. To solve these problems, the present invention stores the minimum note velocity information within the driver electronics, which are preferably configured to receive MIDI signals or signals which are similar to the MIDI format. The controller can thus use all available levels of note velocity (i.e. 0 to 127 within the MIDI standard), prior to the application of the minimum note velocity offsets. In addition, by applying note velocity correction at the solenoid driver circuit, MIDI information from sources other than the controller can be directed to the driver circuit of the instrument without losing the benefits of minimum note velocity compensation.

In one embodiment, an apparatus for controlling solenoid velocity in a player piano during playback according to the present invention comprises:

(a) means for determining minimum velocity compensation for the keys of a piano; (b) a solenoid driver circuit configured for actuating the solenoids driving the keys of the piano; and (c) means for modulating note velocities within the solenoid driver circuit. The note velocities are received by the solenoid driver circuit and modulated by the modulating means in response to the minimum velocity compensation prior to output to the solenoids, or other forms of actuation, during playback.

The means for modulating note velocity comprises circuitry which generates actuator output signals in response to the sum of the requested velocity for a given note and the minimum velocity compensation value for that note. Although preferably implemented digitally, in particular with a microprocessor or microcontroller, the modulation can be implemented using discrete logic, programmable logic, analog circuitry, neural net processing, or combinations thereof, without departing from the teachings of the present invention.

The solenoid driver circuit may receive a note stream from the control box, or more preferably, be additionally configured to receive a note stream from other sources. Therefore, a note stream received by the driver circuit from any source can thus be compensated for minimum note velocity to provide improved note output consistency.

The modulation of note velocities preferably comprises adding minimum velocity compensation to each requested note velocity, although note velocity may be scaled up in other ways without departing from the teachings of the present invention. Specifically, the compensation need not be strictly additive, but may involve modifying the minimum velocity value and applying it in some manner to scale up the output toward normalizing sound output at the lowest volume settings. The requested note velocities are within a range of n values while the solenoid driver circuit is configured to output note velocities within a range of drive velocity values m. The value range m is greater than the value range n (m>n), preferably by an amount approaching or more preferably exceeding the maximum expected value for the minimum note velocity for any of the notes.

Considering the example of a MIDI input note, 128 velocity levels (n) are available (actually 127 values with a 0 value indicating an Off state). In the case of a MIDI stream, if the maximum expected value for minimum note compensation were 20 (largest value that could be assumed during the minimum note velocity learning process), then the value for m should approach or exceed 147 levels. By way of example, the driver may be configured to support 255 levels (i.e. an 8 bit drive value with a 0=Off level).

In one embodiment of the invention the learning mode of the control box is optionally configured to check the minimum note velocity compensation value against a threshold value for the instrument. It should be appreciated that excessive compensation can be indicative of a dirty key mechanism, or mechanical problems with a key, wherein the instrument should be serviced. This embodiment of the control box, therefore, optionally determines if excessive compensation is required and alerts the user to these excessive compensation conditions.

A preferred embodiment of this compensation threshold aspect of the invention is configured to output velocity values starting from 0 and increasing with each subsequent strike until either an audible condition is signaled or a compensation threshold is reached. If the compensation threshold has been reached without an audible response being signaled then the key is first preferably retested to verify that a problem exists. If a bona fide compensation problem exists, then the user is alerted. In this embodiment learning mode continues for all keys even when the compensation threshold is reached for one or more keys.

It should be appreciated that minimum velocity compensation can be determined in response to detecting the minimum velocity of a key which results in an audible output (i.e. sensed by a user manually, or by one or more acoustic transducers), or mechanical activation of the string (i.e. sensed optically or electromechanically) which should correspond to a given low audio output condition for the keystroke. The detection of the minimum note velocity for each key can be detected automatically during the learn process in response to a sensor, or manually in response to user feedback.

Typically, the control box is configured for performing a learning sequence for the keys and outputting minimum note velocity information for each key to the solenoid driver circuit; however, the driver circuit itself may be less preferably configured for determining the note velocity correction factors on its own. The minimum note velocity information may be stored in a separate table in the driver circuit or adjustments made to a compensation mechanism (i.e. expression table, curves, equations, etc.) within the driver circuit which may include compensation for any desired number of additional variables.

In another embodiment, the invention comprises: (a) a player piano control box configured for determining minimum note velocity compensation for each of the piano keys; (b) a solenoid driver circuit coupled to the control box and configured for, (i) receiving and storing minimum velocity compensation information from the control box, (ii) modulating received note velocities during playback in response to the minimum velocity compensation information, and (iii) generating output signals for driving an actuator in response to the received note velocities which have been modulated by the minimum velocity compensation information.

In another embodiment the inventions comprises: (a) a player piano control box having electronics configured for determining minimum velocity compensation for each of the keys of the piano; (b) a solenoid driver circuit coupled for communication with the control box and configured for receiving a note velocity value within the MIDI stream having n possible states and for outputting a solenoid drive velocity signal having m possible states, wherein m has a larger number of possible states than n; (c) a microprocessor and memory within the solenoid driver; and (d) programming executable on the microprocessor for, (i) receiving and storing minimum note velocity compensation information from the control box into the memory, (ii) modulating received note velocities during playback in response to the minimum velocity compensation information, and (iii) generating output signals for actuating solenoids to drive the keys of the piano in response to the received note velocities which have been modulated by the minimum velocity compensation information.

The programming of the driver controller is preferably configured for modulating the requested note velocity for each key with a minimum note compensation value stored in memory without curtailing the available range of note velocity values for driving the key actuators, typically solenoids. This modulation requires that the output range of velocities for the driver (m states) exceed the input range of velocities (n states). The value of m preferably exceeds the value of n by a value which equals or exceeds the maximum value to which the minimum note velocity compensation can be set for any given key. The difference between m and n can be less than the maximum value to which the minimum note velocity compensation can be set, although some velocity range clipping can then arise at the upper end of the velocity range.

In a further embodiment, a method of controlling key actuation within an electronic player piano according to the invention comprises: (a) storing a learning table including empirically determined minimum note velocity values for access by a solenoid driver section of the player piano; (b) mapping, within the solenoid driver section, each received velocity value through an expression table into a force value; and (c) compensating the force value of the solenoid driver section for each received note based on the learning table to normalize piano key output during playback.

Embodiments of the present invention can provide a number of beneficial aspects which can be implemented either separately or in any desired combination without departing from the present teachings.

An aspect of the invention is to provide improved note velocity consistency within a player piano.

Another aspect of the invention is to provide a method of compensating for minimum note velocity variations without curtailing the available range of maximum note velocity.

Another aspect of the invention is to provide a method of compensating for minimum note velocity regardless of whether the note velocity information is received from a control box or from another source.

Another aspect of the invention is to provide note velocity compensation which can extend beyond the 0 to 127 level limitations of the MIDI standard.

A still further aspect of the invention is to provide a method of compensating for minimum note velocity which can be readily implemented in player piano systems.

Further aspects of the invention will be brought out in the following portions of the specification, wherein the detailed description is for the purpose of fully disclosing preferred embodiments of the invention without placing limitations thereon.

### BRIEF DESCRIPTION OF THE SEVERAL VIEWS OF THE DRAWING(S)

The invention will be more fully understood by reference to the following drawings which are for illustrative purposes only:

FIG. 1 is a flowchart of conventional minimum note velocity processing within a control box of a player piano.

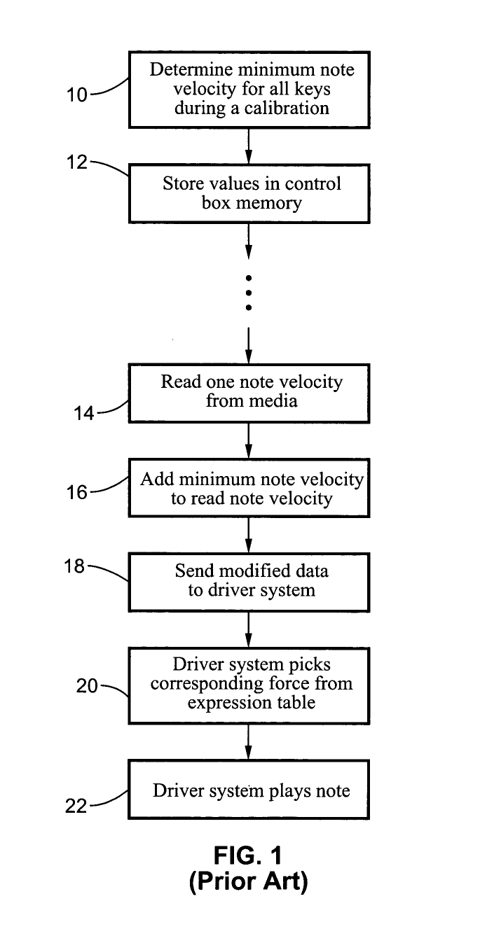

FIG. 2 is a block diagram of a player piano control box and driver electronics according to an embodiment of the present invention, shown with minimum note velocity processing performed within the driver circuitry.

FIG. 3 is a flowchart of minimum note velocity processing according to an embodiment of the present invention.

### DETAILED DESCRIPTION OF THE INVENTION

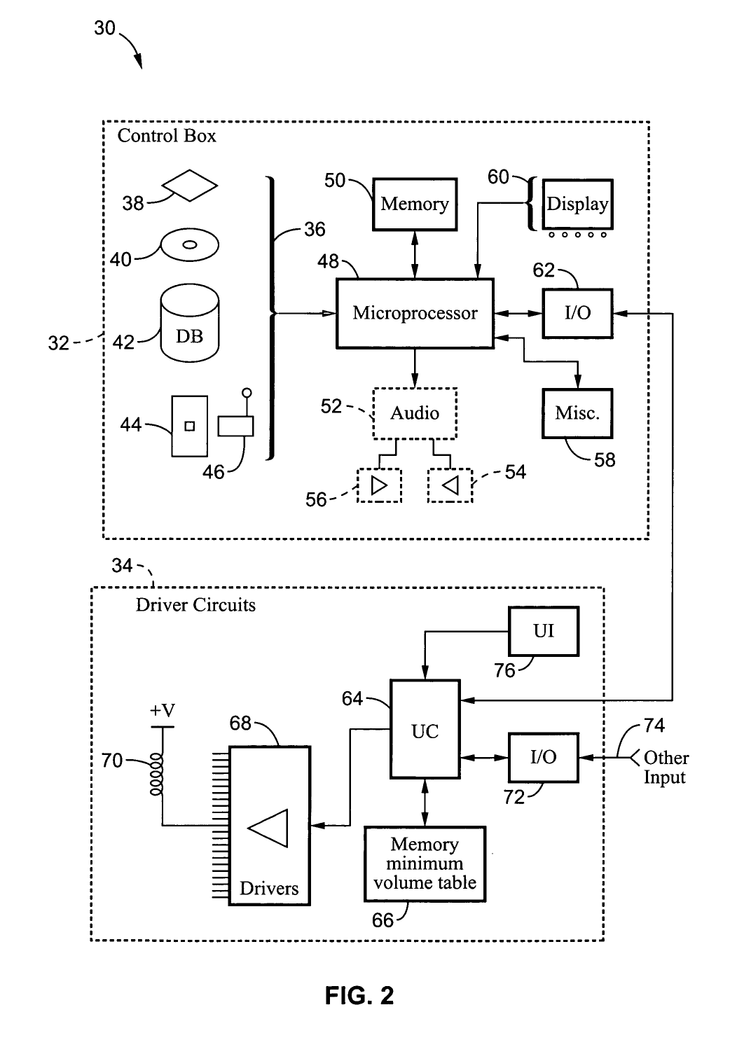

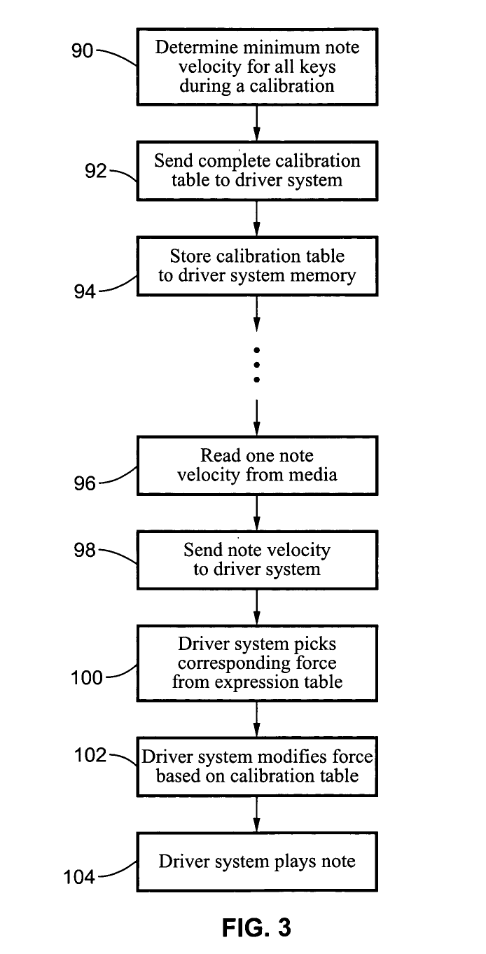

Referring more specifically to the drawings, for illustrative purposes the present invention is embodied in the apparatus and method generally shown in FIG. 2 through FIG. 3. It will be appreciated that the apparatus may vary as to configuration and as to details of the parts, and that the method may vary as to the specific steps and sequence, without departing from the basic concepts as disclosed herein.

The present invention provides an apparatus and method of performing minimum note velocity compensation without sacrificing playback consistency at the upper end of the note velocity range. It has not been fully appreciated in the industry that providing note velocity compensation in a control unit which itself outputs a MIDI stream inherently results in a loss of usable MIDI velocity levels.

Therefore, the present invention describes an apparatus and method which includes storage of minimum note velocity information (i.e. learning table, expression table, etc.) within the driver system instead of the control box. The control box can thus send any desired note velocity in the MIDI range from 0 to 127, while the compensation is performed at a driver which is configured to support an extended output range. For example, consider an embodiment in which the driver can support an eight bit solenoid output value range, from 0 to 255. Assume a requested note velocity value of 125 for note D within a note stream received by the control box. The control box would output a velocity of 125 to the solenoid driver circuit which would be compensate for minimum volume by adding 15 to it according to our earlier example in which the minimum note velocity for note D was determined to be 15, wherein the driver circuit would generate a driver output of 140.

It should be appreciated that the output values being used by the driver for controlling actuator activation can comprise any controllable metric. The output stages of the driver can utilize the values received within range m to drive any desired forms of output whether they be driven by analog voltage, analog current, pulse width modulation (PWM), digital control signals, other forms of actuator control signals, or combinations thereof.

It will be readily appreciated that driver stage minimum note velocity compensation improves the consistency of note outputs at high note velocities as well as providing other advantages. By way of example, note velocity compensation in the driver section allows a MIDI stream to be sent directly to the driver section from any MIDI output source and the notes being played will be properly compensated. Therefore, the instrument can also be controlled by note stream sources, other than those integrated with the control box, which do not have access to minimum note compensation information.

FIG. 2 illustrates an example of player piano electronics 30 having a control box 32 and driver circuits 34. An instrument control data stream is received from a source device 36, such as memory device 38 (i.e. memory card, stick, etc.), removable media 40 (i.e. CD ROM, DVD, floppy disk, etc.), fixed media 42 (i.e. disk drive, non-removable memory, etc.), or a transmission medium over which the playback information is received from external device 44 having wired or more preferably wireless connectivity 46.

It will be appreciated that control box 32 can support any desired number and configuration of input and output ports without departing from the teachings of the present invention. In this embodiment the control data is received within a microprocessor 48 coupled to memory 50, which can retain programming and data. The control box 32 is configured for controlling the operation of at least one associated instrument, preferably a piano, and may also be adapted for controlling additional instrument accompaniments, or for controlling other outputs.

One preferred form of output is from an audio system 52 for generating audio outputs through amplifiers 54, 56 (or pre-amplifiers) toward driving acoustic transducers (i.e. speakers). It will be appreciated that the audio may be generated in response to a set of MIDI data from the source, or the playing of actual tracks of music synchronized with playback from the player piano.

Control box 32 can support any desired playback related functionality 58 and preferably a user interface 60, such as control inputs and a display. Control box 32 provides at least one communications port 62 for communicating with driver circuit electronics 34.

Driver circuit 34 can also be generally referred to as a “solenoid driver circuit” because key actuation is typically controlled by solenoids, although other actuator forms may be similarly employed. A microprocessor 64 and memory 66 preferably provide control functionality within driver circuit 34, although non-programmable control elements may be less preferably utilized instead. Microprocessor 64, or other control circuits, are adapted for controlling a series of key actuation outputs, such as from a driver chip 68, or series of driver chips. Driver chip 68 is shown by way of example coupled to coil 70 of a key solenoid although other actuators may be similarly utilized. It should be appreciated that the driver chips may be located together in the circuit, or located in a distributed manner, such as spanning the set of actuators. For example, in one embodiment a driver circuit may be coupled to each solenoid assembly wherein parallel or preferably serial drive signals from driver circuit 34 control drivers co-located with the actuators.

Optionally, driver circuit 34 can be configured with an external input port 72 for receiving external driver input 74, such as from a source of instrument control information (i.e. note stream) other than control box 32. Driver circuit 34 may also be configured with its own user interface 76, thereby allowing minimum note velocities to be determined by the driver circuit itself if desired.

Control box 32 typically provides the means of determining minimum note velocity for each of the keys. During the learning mode, control box 32 preferably actuates each key at different note velocities for determining the minimum note velocity which produces an audible output. The determination of whether or not the key strike is audible can be determined manually by a user, or by relying on some form of mechanical, optical or acoustic sensor, or a combination thereof. In one example embodiment control box 32 outputs a sequence of increasing note velocities to a given key until the user responds to indicate that the note was audible, such as by pressing the associated piano key, or otherwise generating an input (i.e. input buttons or selectors) that is read by the controller. Control box 32 then proceeds to generate a sequence of velocities for each key and to capture the user response that identifies the minimum audible note velocity for each of the keys.

According to another embodiment minimum note velocity can be determined automatically without relying on human intervention and with additional user benefits in speed and simplification. An embodiment can be implemented with one or more sensors coupled to the controller for sensing acoustic output from the strings being struck, sensing string motion or vibration, sensing the velocity of the hammer mechanism as the string is about to be struck, or other techniques which can be directly or indirectly correlated with audio output of the given note. In an automated system, the minimum note velocity can be determined sequentially for each key in a manner similar to that utilized for the manual case. Alternatively, the same note velocity may be generated for each of the keys sequentially while sensing for an audible or mechanical string response, and then the next level of note velocity can be output sequentially to all keys and so forth. One advantage of this second approach is that the learn process is less subject to changes due to solenoid heating. It will be appreciated that minimum audible note velocity learning may be implemented in numerous alternative ways without departing from the teachings of the present invention.

FIG. 3 illustrates a flowchart of the method of performing minimum note velocity compensation within an embodiment of the present invention.

Represented by block 90 is the determination of minimum note velocity (i.e. manually, automatically, or a combination thereof) for each of the notes of the instrument, preferably keys on a piano. Minimum note velocity information is communicated as per block 92 to the driver system, such as being sent from the control box to the driver circuit for storage.

Minimum note velocity information is preferably communicated as a minimum audible note value for each key, however, it may alternatively comprise a series of values, a curve, a set of coefficients, and so forth for representing information about the minimum note velocity. The minimum note velocity value may also be utilized to modify entries in a note expression table within the driver which can contain any desired number of correction factors.

In this way a single lookup in the expression table can compensate for a number of factors for each note and note velocity thereof.

It should also be noted that although the minimum note velocity information is described as being generated by a control box it may alternatively be generated by other circuit elements, or determined in response to learn mode activity on the part of the driver circuit itself. Minimum note velocity information is stored in the driver circuit as per block 94, such as within a calibration or expression table.

Once minimum note velocity information has been stored for each key, the piano can utilize the information during playback to provide more consistent audio output for a given audio input. The next series of blocks in the flowchart (blocks 96-104) depict playback of a stream of notes. One note is received by the driver as per block 96, such as from a source media attached to control box 32 (FIG. 2) or alternatively a source is coupled directly to driver circuit 34 (FIG. 2). The note velocity information is received within the driver circuit as per block 98 and the driver circuit modulates the note velocity in response to the learned minimum note velocity, such as by picking a corresponding force value from an expression table as depicted by block 100. The force to be output is modified as per block 102 taking into account the minimum note velocity contribution, and the driver system outputs a velocity signal as per block 104 for directly or indirectly driving the key actuator means (i.e. solenoid, linear actuator, pneumatic actuator, and so forth) to create the note during playback.

It should be appreciated that embodiments of the control box and driver were provided by way of example and significant modifications to these elements can be implemented by one of ordinary skill in the art without departing from the teachings of the present invention. It should also be appreciated that although the present invention is particularly well-suited for use on player piano instruments, it can be less preferably applied to other forms of player instruments controlled by an electronic note stream, such as MIDI note streams.

Although the description above contains many details, these should not be construed as limiting the scope of the invention but as merely providing illustrations of some of the presently preferred embodiments of this invention. Therefore, it will be appreciated that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more.” All structural and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for.”

TABLE 1
Example Case of Minimum Note Velocity Compensation

| Note | Minimum NV | Requested NV | Output NV |
|---|---|---|---|
| C | 10 | 40 | 50 |
| D | 15 | 40 | 55 |
| G | 2 | 40 | 42 |

What is claimed is:

1. An apparatus for controlling note actuation velocity in a musical instrument during playback, comprising:
means for determining minimum velocity compensation for notes of a musical instrument;
an actuator driver circuit configured for activating note actuators in the musical instrument; and
means for modulating note velocities within said actuator driver circuit;
wherein said note velocities are received by said actuator driver circuit and modulated by said means for modulating note velocities in response to said minimum velocity compensation prior to output to the note actuators during playback.

2. An apparatus as recited in claim 1, wherein said means for modulating note velocities comprises circuitry configured to generate actuator output signals in response to the sum of a requested velocity for a given note and a minimum velocity compensation value for said note.

3. An apparatus as recited in claim 1:
wherein said note velocities may be any of n values wherein said actuator driver circuit is configured to output any of m values of drive velocity; and
wherein the value of m is greater that the value of n.

4. An apparatus as recited in claim 3, wherein the value of n is 128 according to the musical instrument data interchange (MIDI) standard.

5. An apparatus as recited in claim 3, wherein said value of m is greater than n by a value which is equal to or exceeds the minimum velocity compensation.

6. An apparatus as recited in claim 1, wherein said minimum velocity compensation is determined in response to detecting the minimum note velocity which results in an audible output.

7. An apparatus as recited in claim 1, wherein said means for determining minimum velocity compensation comprises a control box configured for performing a note learning sequence and outputting the minimum velocity values for each note to said actuator driver circuit.

8. An apparatus as recited in claim 7, further comprising an expression table within said actuator driver circuit which is configured for storing minimum velocity values received from said control box.

9. An apparatus as recited in claim 7, further comprising circuitry on said actuator driver circuit for receiving note information signals from a source other than said control box.

10. An apparatus for controlling solenoid velocity in a player piano during playback, comprising:
a control box of a player piano, said control box configured for determining minimum velocity compensation for each of the keys of the piano;
wherein said minimum velocity compensation is determined in response to detecting the minimum velocity of a key which produces an acoustic output corresponding to the key; and
a solenoid driver circuit coupled to said control box and configured for,
receiving and storing minimum velocity compensation information from said control box,
modulating received note velocities during playback in response to said minimum velocity compensation information, and
generating output signals for driving an actuator in response to said received note velocities which have been modulated by said minimum velocity compensation information.

11. An apparatus as recited in claim 10, wherein said step of modulating received note velocities comprises adding minimum velocity compensation to each note velocity prior to generating an output signal.

12. An apparatus as recited in claim 10:
wherein said note velocities may be any of n values while said solenoid driver circuit is configured to output any of m values of drive velocity; and
wherein the value of m is greater that the value of n.

13. An apparatus as recited in claim 12:
wherein said note velocity is received as part of note information within a musical instrument data interchange (MIDI) stream;
wherein the value of n is 128 as defined within the MIDI standard; and
wherein said value of m is greater than 128 by a value which is equal to or exceeds the maximum allowable value for minimum note velocity compensation.

14. An apparatus as recited in claim 10, further comprising circuitry on said solenoid driver circuit for receiving note information signals from a playback note source other than said control box.

15. An apparatus for controlling solenoid velocity in a player piano receiving a MIDI note stream, comprising:
a control box having circuitry configured for determining minimum velocity compensation in response to detecting the minimum velocity of a key which produces an audible output, for each of the keys of an associated player piano;
a solenoid driver circuit coupled for communication with said control box;
wherein said solenoid driver is configured for receiving a note velocity value within the MIDI stream having n possible states and for outputting a solenoid drive velocity signal having m possible states;
wherein the value m has a larger number of possible states than the value n;
a microprocessor and memory within said solenoid driver; and
programming executable on said microprocessor for,
receiving and storing minimum note velocity compensation information from said control box into said memory,
modulating requested note velocities received within a playback note stream in response to said minimum note velocity compensation information, and
generating output signals for actuating solenoids to drive the keys of the piano in response to the modulated note velocities.

16. An apparatus as recited in claim 15, wherein said programming is configured for modulating the requested note velocity for each key with a minimum note compensation value stored in memory without reducing the available range of note velocity being output.

17. An apparatus as recited in claim 15:
wherein said note velocity is received as part of note information within a musical instrument data interchange (MIDI) stream;
wherein the value of n is 128 as defined within the MIDI standard; and
wherein said value of m is greater than 128 by a value which is equal to or exceeds the maximum value to which the minimum note velocity compensation can be set for any given key.

18. A method of controlling key actuation within an electronic player piano comprising:
storing a learning table comprising empirically determined minimum note velocity values for each piano key for access by a solenoid driver section of the player piano;
mapping, within the solenoid driver section, each requested note velocity value through an expression table into a solenoid force value; and
compensating the solenoid force value of said driver section for each received note based on the learning table to normalize the output of each piano key during playback.

19. A method as recited in claim 15, wherein said learning table of minimum note velocity values is determined by a control box in response to the execution of a minimum note velocity learning mode for the piano.

20. A method as recited in claim 15, wherein velocity information is received for each note according to the musical instrument data interchange (MIDI) standard.
